(19) United States
(12) Patent Application Publication
(10) Pub. No.: US 2015/0347989 A1
(43) Pub. Date: Dec. 3, 2015

(54) Payment Gateway Interface

(71) Applicant: Cisco Technology, Inc., San Jose, CA (US)

(72) Inventors: Sangeeth Kumar S, Tamil Nadu (IN); Shams Thabrez, Karnataka (IN)

(73) Assignee: Cisco Technology, Inc., San Jose, CA (US)

(21) Appl. No.: 14/288,474

(22) Filed: May 28, 2014

(51) Int. Cl. G06Q 20/02; G06F 17/30

(52) U.S. Cl. CPC G06Q 20/027; G06F 17/30923

(57) ABSTRACT

Techniques and apparatus are described that enable electronic payment transactions over a network, such as the Internet. A technique, in a web re-direction embodiment, includes receiving a generic payment request from an electronic commerce web application, the generic payment request including at least an indication of a type of payment to be completed, preparing a payment gateway-specific web request that is supportive of the type of payment to be completed, passing the payment gateway-specific web request to the electronic commerce web application for delivery to a payment gateway for which the payment gateway-specific web request was prepared, receiving a payment gateway-specific web response from the payment gateway via the electronic commerce web application, processing the payment gateway-specific web response, and returning, to the electronic web application, a generic payment response including, at least, an Internet Protocol (IP) address of the payment gateway.

### TECHNICAL FIELD

The present disclosure relates to online payment transactions.

### BACKGROUND

Many commercial websites that accept online payment from users integrate, e.g., communicate, with one or more web-based Payment Gateways rather than providing their own payment systems. There are several Payment Gateways around the world, each catering to regional needs and compliant to regional financial or government policies. Commercial websites that have a global clientele may therefore need to communicate with multiple regional Payment Gateways in order to ensure security and reliability for their customers and to comply with rules and regulations local to a given paying user. Furthermore, such commercial websites may need to support more than one mode of Internet based payment including, but not limited to, credit cards, debit cards, Internet banking, cash cards, online payment (e.g., PayPal™, Google Wallet™) etc.

### BRIEF DESCRIPTION OF THE DRAWINGS

FIG. 1 is a block diagram of a network based system that includes a web application, a payment gateway interface unit and multiple payment gateways according to an example embodiment.

FIG. 2 is a block diagram of one possible implementation of a payment gateway interface unit according to an example embodiment.

FIG. 3 depicts payment gateway integration using web redirection according to an example embodiment.

FIG. 4 depicts payment gateway integration using web services according to an example embodiment.

FIG. 5 is another block diagram of a payment gateway interface unit according to an example embodiment.

FIG. 6A depicts the interaction among various interfaces within the payment gateway interface unit according to an example embodiment.

FIGS. 6B and 6C depict several entities that are used to communicate information between interfaces according to an example embodiment.

FIGS. 7A, 7B and 7C depict payments forms that might be presented to a user via a payment gateway interface unit according to an example embodiment.

FIGS. 8A and 8B are flowcharts showing operations performed to conduct a financial transaction using a credit card and a payment gateway interface unit according to an example embodiment.

FIGS. 9A and 9B are flowcharts showing operations performed to conduct a financial transaction using an online payment form of payment via a payment gateway interface unit according to an example embodiment.

### DESCRIPTION OF EXAMPLE EMBODIMENTS

### Overview

Presented herein are techniques to enable electronic payment over a network, such as the Internet. A technique, in a web re-direction embodiment, includes receiving a generic payment request from an electronic commerce web application, the generic payment request including at least an indication of a type of payment to be completed, preparing a payment gateway-specific web request that is supportive of the type of payment to be completed, passing the payment gateway-specific web request to the electronic commerce web application for delivery to a payment gateway for which the payment gateway-specific web request was prepared, receiving a payment gateway-specific web response from the payment gateway via the electronic commerce web application, processing the payment gateway-specific web response, and returning, to the electronic web application, a generic payment response including, at least, an Internet Protocol (IP) address of the payment gateway.

In a web services embodiment, a technique includes receiving a generic payment request for a payment transaction from an electronic commerce web application, the generic payment request including at least an indication of a type of payment to be completed, preparing a payment gateway-specific request that is supportive of the type of payment to be completed, sending the payment gateway-specific request to a payment gateway for which the payment gateway-specific request was prepared, receiving a payment gateway-specific response from the payment gateway, processing the payment gateway-specific response, and returning, to the electronic commerce web application, a generic payment response including, at least, an indication that the payment transaction has completed.

An apparatus is also disclosed that enables the foregoing web redirection and web services techniques.

### EXAMPLE EMBODIMENTS

In order to be competitive in global commerce, commercial websites are often configured to accept different forms of payment. Moreover, such commercial websites might need to be compliant with respective local or regional regulations concerning online financial transactions. As a result, commercial websites can quickly become complex systems by catering to multiple payment regimes and standards.

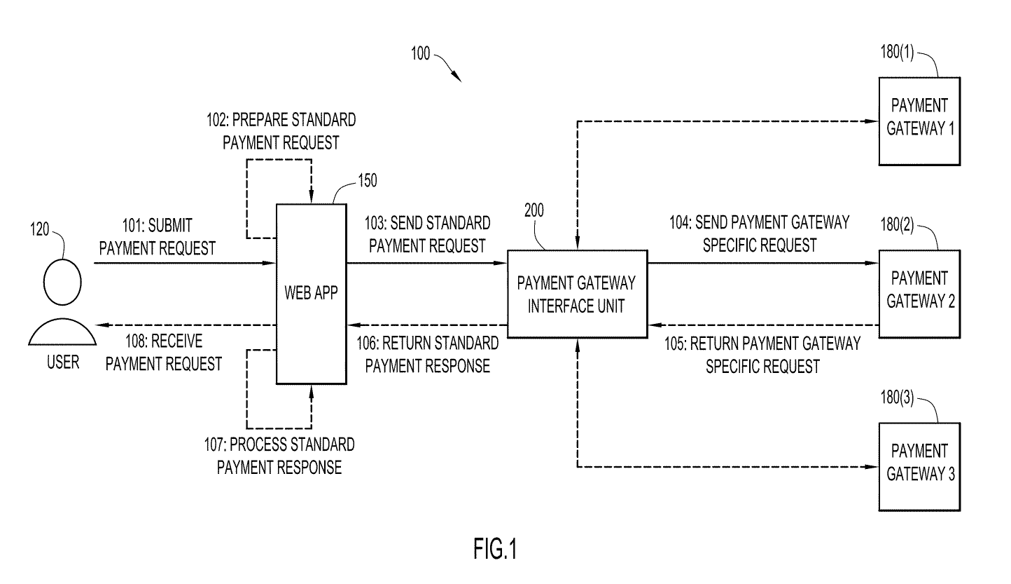

FIG. 1 is a block diagram of a network based system 100 that includes a Web Application 150, a Payment Gateway Interface Unit 200 and multiple Payment Gateways 180(1), 180(2), 180(3) (hereinafter, generally, “180”) according to an example embodiment. At a high level, a user 120 may visit a website presented by Web Application 150. Upon deciding to make a purchase or, more generally, make a payment of some sort, user 120 submits a payment request at 101. Web Application 150 receives the payment request and at 102 prepares a Standard Payment Request. As will be more fully explained later herein, the Standard Payment Request is configured to be a generic payment request regardless of the form of payment to be made. At 103, the Standard Payment Request is sent to Payment Gateway Interface Unit 200. Payment Gateway Interface Unit 200 is configured to generate a payment gateway-specific request and at 104 to transmit that gateway-specific request to a selected (i.e., a specified) Payment Gateway 180. At 105, payment gateway 180 returns a Payment Gateway-Specific Response to Payment Gateway Interface Unit 200.

Payment Gateway Interface Unit 200 is configured to convert the received Payment Gateway-Specific Response into a Standard Payment Response and at 106 return the Standard Payment Response to Web Application 150. Web application 150 processes the Standard Payment Response at 107 and, at 108, sends a payment response to user 120.

Thus, as will be explained in more detail below, Payment Gateway Interface Unit 200 is configured to receive a standard payment request and then identify and communicate with an appropriate Payment Gateway 180 in order to complete a particular payment transaction consistent with a given user's intention. That is, Payment Gateway Interface Unit 200 is configured to enable Web Application 150 to send a generic or standard payment request to initiate a payment transaction. As a result, Web Application 150 need not be coded with the specific application programming interfaces (APIs) that respective Payment Gateways 180 might publish to enable access to the respective Payment Gateways 180. In other words, Payment Gateway Interface Unit 200 is configured to operate independently of Web Application 150 and provide a mechanism via which Web Application 150 can access any one of a plurality of Payment Gateways without having any programming code that is specific to any of the Payment Gateways.

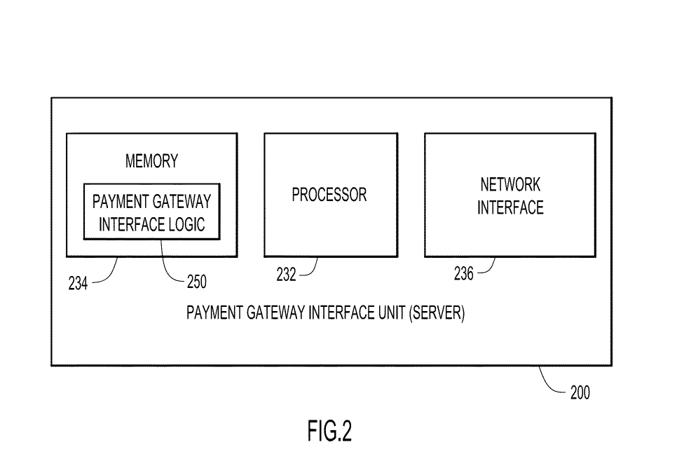

FIG. 2 is a block diagram of one possible implementation of Payment Gateway Interface Unit 200 according to an example embodiment. Payment Gateway Interface Unit 200 includes a processor 232 to process instructions relevant to payment transactions supported by payment gateway interface unit 200, and memory 234 to store a variety of data and software instructions (e.g., payment gateway interface logic 250, etc.). Payment gateway interface unit 200 also includes a network interface unit (e.g., a network interface card (NIC)) 236 to communicate with other devices over an electronic network, such as the Internet. Memory 234 may comprise read only memory (ROM), random access memory (RAM), magnetic disk storage media devices, optical storage media devices, flash memory devices, electrical, optical, or other physical/tangible (e.g., non-transitory) memory storage devices. Processor 232 is, for example, a microprocessor or microcontroller that executes instructions for implementing the processes described herein. Thus, in general, memory 234 may comprise one or more tangible (non-transitory) computer readable storage media (e.g., a memory device) encoded with software comprising computer executable instructions, and when the software is executed by, e.g., processor 232, processor 232 is operable to perform the operations described herein.

Payment gateway integration, i.e., enabling a given web application to support multiple Payment Gateways via Payment Gateway Interface Unit 200, may be accomplished in one of several ways, including web application redirection, web services, and/or a combination of the two.

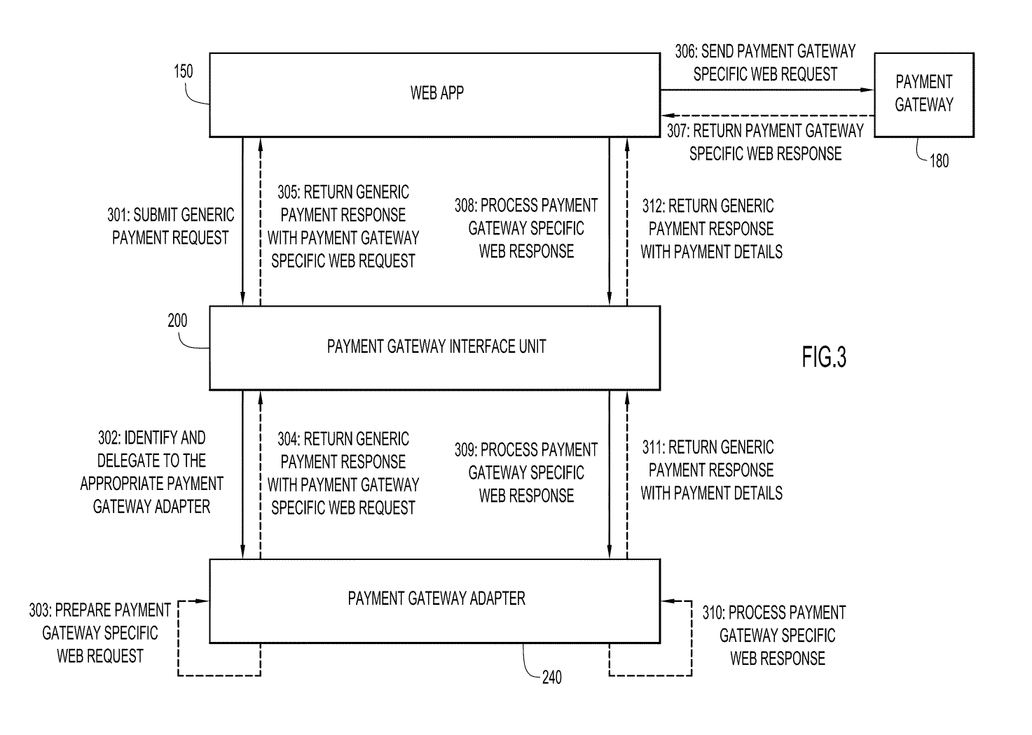

FIG. 3 depicts payment gateway integration using web application redirection according to an example embodiment.

In web application redirection, once user 120 initiates payment from a payment page in web application 150, the request is directed to a payment page in Payment Gateway 180. Once user 120 submits relevant input (e.g., credit card information), Payment Gateway 180 completes the payment and redirects the request to Web Application 150 with details related to the payment transaction, e.g., a transaction-reference-id, status of payment, etc. FIG. 3 shows multiple operations with respect to Web Application 150 and Payment Gateway 180 and how payment gateway interface unit 200 orchestrates a given payment transaction.

Specifically, at 301, Web Application 150 using APIs provided by Payment Gateway Interface Unit 200 prepares a “standard” payment request and submits such a standard or generic payment request to Payment Gateway Interface Unit 200.

Upon receiving the payment request, Payment Gateway Interface Unit 200 creates a new Payment Transaction. Then, at 302, with the help of payment gateway integration configuration discussed later herein, a suitable payment gateway adapter 240 is selected for processing the given payment request and Payment Gateway Interface Unit 200 submits (i.e., delegates) the request to the identified payment Gateway Adapter 240.

At 303, Payment Gateway Adapter 240 uses the payment request details and prepares a relevant Payment Gateway specific HTTP request. The format and content of the Payment Gateway specific HTTP request is consistent with, e.g., an API published by Payment Gateway 180 or an organization that is responsible for maintaining Payment Gateway 180.

At 304, Payment Gateway Adapter 240 returns the Payment Gateway specific HTTP request as a standard payment response to Payment Gateway Interface Unit 200.

At 305, payment gateway interface unit 200, on receiving the standard payment response updates the Payment Transaction with a current status and updates the standard payment response with the transaction reference. Then the standard payment response is returned to Web Application 150.

At 306, Web Application 150, once it receives the standard payment response, stores the Payment Transaction reference id and transmits the HTTP request to Payment Gateway 180. A website associated with Payment Gateway 180 presents a payment page to user 120. User 120 thereafter submits input associated with a given type of payment. The website associated with Payment Gateway 180 approves and completes the payment.

At 307, the website associated with Payment Gateway 180 redirects back to Web Application 150. An associated HTTP request carries the details about the payment operation in the Payment Gateway website.

At 308, however, Web Application 150 may not be able to understand the data received. Hence it sends the headers, query parameters and body of the HTTP request to the Payment Gateway Interface Unit 200 for interpretation, along with the original payment transaction reference id.

At 309, Payment Gateway Interface Unit 200 validates whether the given payment transaction reference id is valid, restores the associated payment transaction, and submits the given payment gateway response to the same Payment Gateway Adapter 240 which was last used by the payment transaction

At 310, Payment Gateway Adapter 240 understands and processes the details received, and prepares a standard payment response.

At 311, Payment Gateway Adapter 240 returns the standard payment response to Payment Gateway Interface Unit 200.

At 312, Payment Gateway Interface Unit 200 updates the payment transaction and returns the standard payment response to Web Application 150.

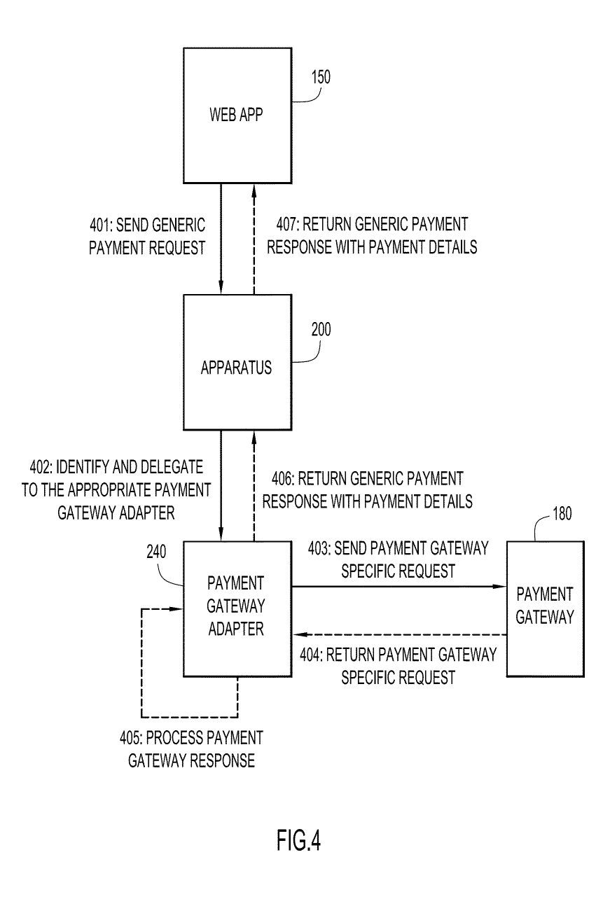

Reference is now made to FIG. 4, which depicts payment gateway integration using web services according to an example embodiment. In this approach, Payment Gateway Adapter 240 does not seek the help of Web Application 150 to complete the payment transaction. Instead Payment Gateway Adapter 240 uses Web Services based on Simple Object Access Protocol (SOAP), Representational State Transfer (REST) or a proprietary protocol to communicate with the relevant Payment Gateway 180 to complete a payments transaction. Once user 120 initiates payment from Web Application 150, the following operations may be performed.

At 401, Web Application 150 using published APIs provided by Payment Gateway Interface Unit 200 prepares a “standard” or generic payment request and submits it to Payment Gateway Interface Unit 200.

On receiving the payment request, Payment Gateway Interface Unit 200 first creates a new Payment Transaction. Then with the help of Payment Gateway Integration configuration, Payment Gateway Interface Unit 200 identifies the most suitable Payment Gateway Adapter 240 for processing the given payment request and, at 402, submits the request to the identified Payment Gateway Adapter 240.

At 403 Payment Gateway Adapter 240 invokes one or more Web Services hosted by Payment Gateway 240 to submit the payment request to Payment gateway 180.

Payment Gateway 180 processes the payment request, validates, and completes the payment and, at 404, returns the response to the Payment Gateway Adapter 240.

At 405, Payment Gateway Adapter 240 translates the response into a standard payment response, including relevant details of the payment.

At 406, Payment Gateway Adapter returns a standard or generic payment response to Payment Gateway Interface Unit 200, which updates the payment transaction

Payment Gateway Interface Unit 200 prepares a standard or generic payment response and returns it to Web Application 150.

Those skilled in the art will appreciate that a given Payment Gateway Adapter 240 can be configured to employ web redirection or web services, as may be preferred for a given transaction. The two approaches could also be combined in a single given transaction.

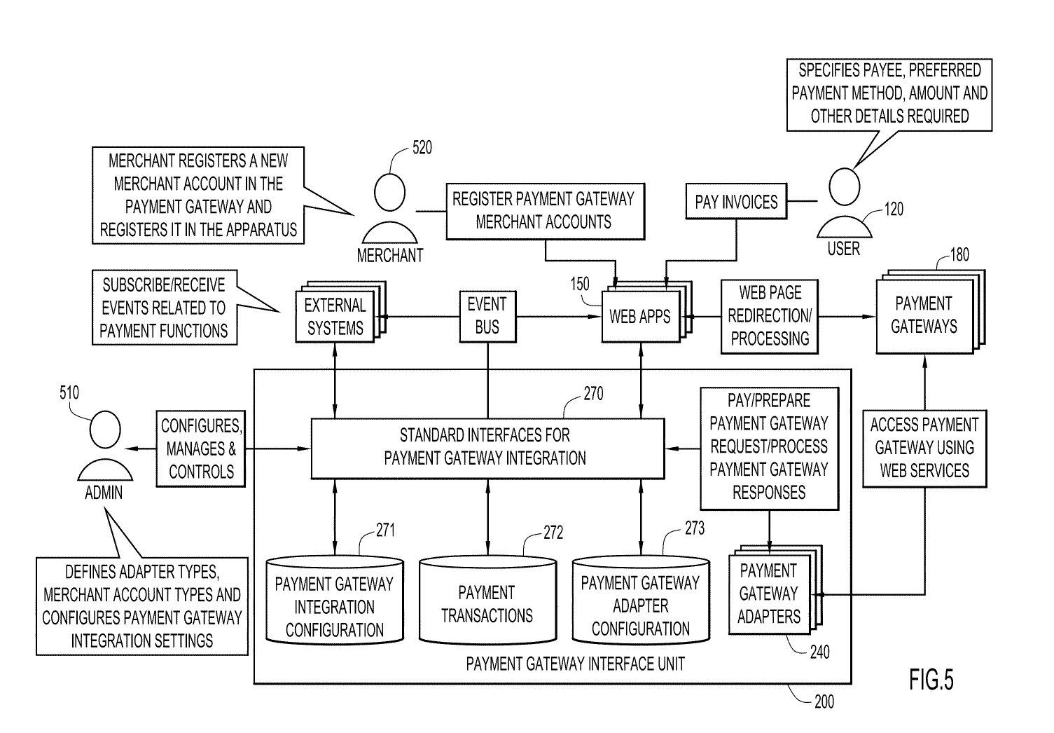

FIG. 5 is another block diagram of a Payment Gateway Interface Unit 200 according to an example embodiment and that is configured to support the web redirection and web services approaches discussed above. Main components include Standard Interfaces for Payment Gateway Integration 270, a data store for Payment Gateway Integration configurations 271, Payment Transactions 272, and Payment Gateway Adapter Configurations 272, and Payment Gateway Adapters 240.

Several types of entities might interact with Payment Gateway Interface Unit 200 including an Administrator 510 who configures the various system-wide Payment Gateway integration configurations 271. Administrator 510 might also be responsible for deploying and configuring various Payment Gateway Adapters 240 to operate with one or more Payment Gateways 180.

A Merchant 520 participates or operates Web Application 150. In order to accept payments, Merchant 520 may register Payment Gateway Account details in Payment Gateway Interface Unit 200, provided Payment Gateway Interface Unit 200 supports an intended Payment Gateway 180.

Customer or user 120 uses various paid services provided by Web Application 150.

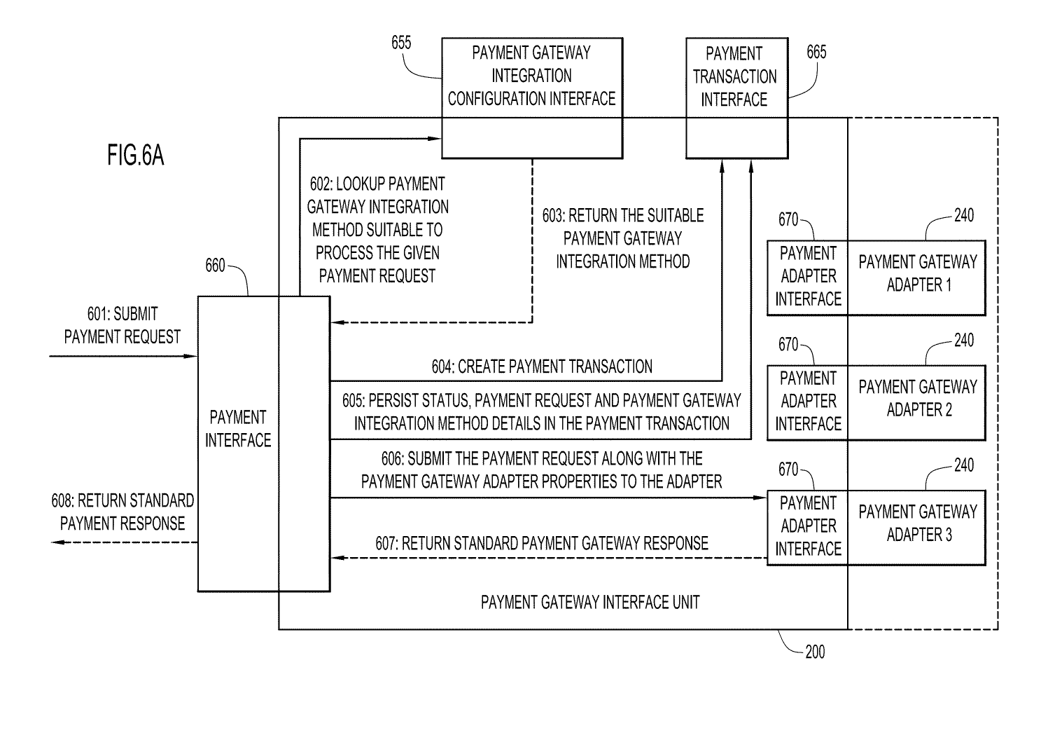

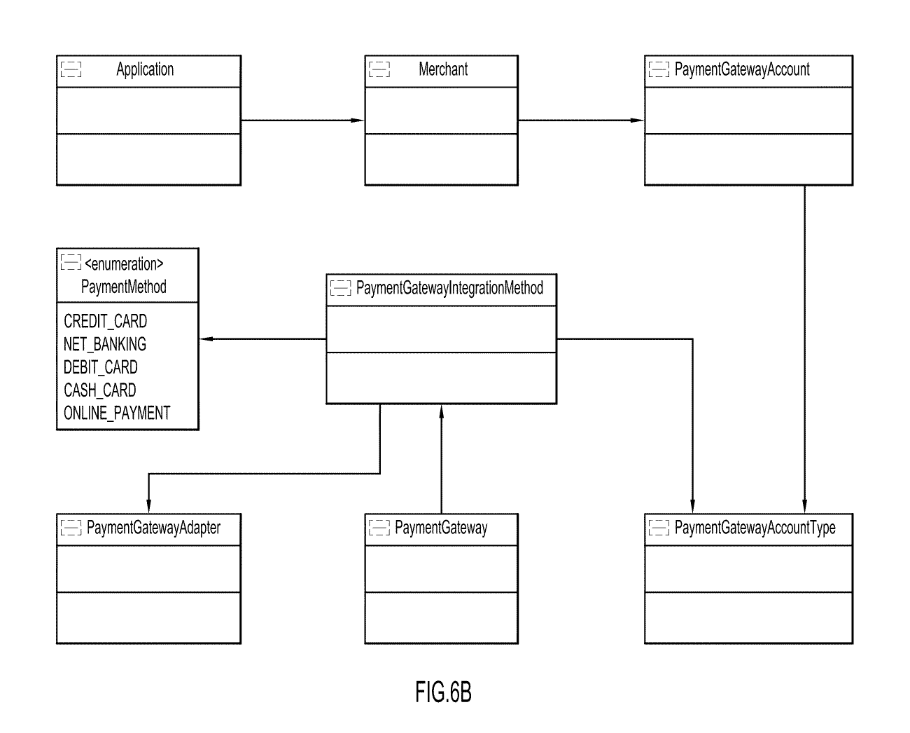

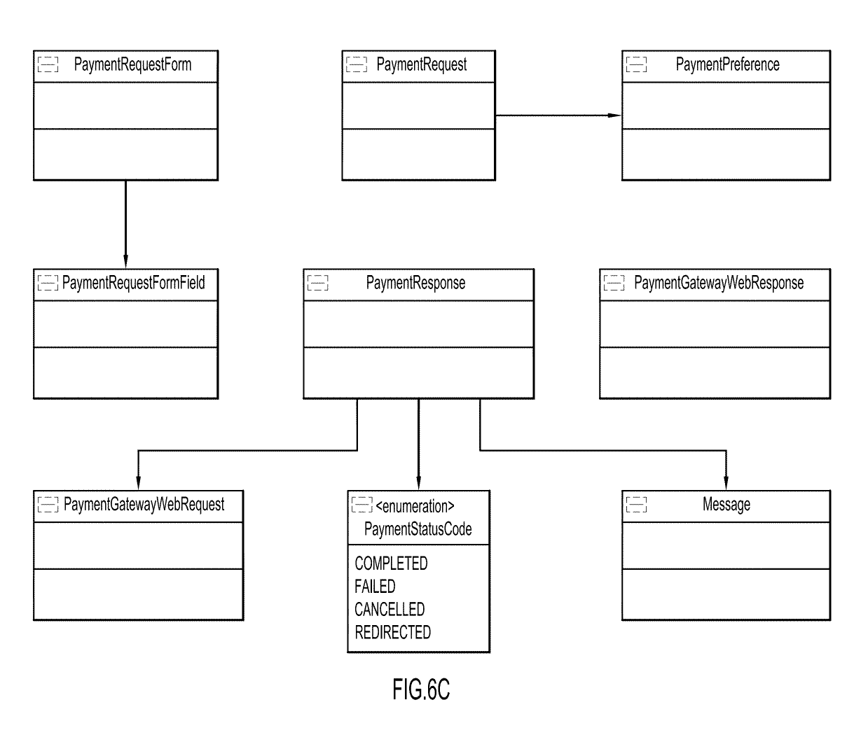

FIG. 6A depicts the interaction among several interfaces within Payment Gateway Interface Unit 200 according to an example embodiment. At a high level the several interfaces enable Payment Gateway Interface Unit 200 to perform payments through virtually any Payment Gateway, track and manage payment transactions, configure Payment Gateway Integration settings, develop adapters for various Payment Gateways, and subscribe to and receive various events related to payment transactions and configuration changes.

More specifically, as shown in FIG. 6A, the several interfaces include a Payment Gateway Integration Configuration Interface 655, a Payment Interface 660, a Payment Transaction Interface 665 and a Payment Adapter Interface 670. Payment Gateway Integration Configuration Interface 655 is configured to assist Administrator 510 of Web Application 150 to register one or more merchants 520 in Payment Gateway Interface Unit 200, so that merchants 520 receive payments through Payment Gateway Interface Unit 200, manage registered merchants 520, and register and manage Payment Gateway account details Payment Gateway Interface Unit 200.

Payment Gateway Integration Configuration Interface 655 is further configured to assist Administrator 520 to register various Payment Gateways so that client-programs can leverage them, define the data structure of different Payment Gateway Accounts of various registered Payment Gateways 180, register and manage Payment Gateway Adapters 240 which enables Payment Gateway Interface Unit 200 to communicate with the various registered Payment Gateways 180, and configure and manage Payment Gateway Integration Methods.

Entities associated with Payment Gateway Integration Configuration Interface 655 are shown in FIG. 6B and each is discussed in turn below.

Application.

The Application entity is the client-program that uses Payment Gateway Interface Unit 200 to perform payments. The Application entity includes details such as name of the application, author of the application, a generated application key and a generated secret key. For security, the application uses an application key and a secret key for interactions with Payment Gateway Interface Unit 200. An XML Schema representation of this entity is as shown below:

<xs:element name=“Application”>

<xs:complexType>

<xs:sequence>

<xs:element name=“id” type=“xs:long”/>
<xs:element name=“name” type=“xs:string”/>
<xs:element name=“description” type=“xs:string”/>
<xs:element name=“author” type=“xs:string”/>
<xs:element name=“website” type=“xs:string”/>
<xs:element name=“applicationKey” type=“xs:string”/>
<xs:element name=“secretKey” type=“xs:string”/>
<xs:element name=“attributes”

type=“pgi:NameValuePairList”/>

</xs:sequence>

</xs:complexType>

</xs:element>

Payment Gateway.

The Payment Gateway entity includes various details of Payment Gateway 180, such as name, website address, whether it is enabled or not, among other possible attributes. An XML Schema representation of this entity is as shown below:

<xs:complexType name=“PaymentGateway”>

<xs:sequence>

<xs:element name=“id” type=“xs:long”/>
<xs:element name=“name” type=“xs:string”/>
<xs:element name=“description” type=“xs:string”/>
<xs:element name=“website” type=“xs:string”/>
<xs:element name=“enabled” type=“xs:boolean”/>
<xs:element name=“attributes” type=“pgi:NameValuePairList”/>

</xs:sequence>

</xs:complexType>

Merchant.

The Merchant entity is an individual or organization registered in an Application and provides paid services or sells commodities. This entity includes details such as the name of the merchant 520 and various attributes about the merchant. An XML Schema representation of this entity is as shown below:

<xs:complexType name=“Merchant”>

<xs:sequence>

<xs:element name=“id” type=“xs:long”/>
<xs:element name=“name” type=“xs:string”/>
<xs:element name=“attributes” type=“pgi:NameValuePairList”/>

</xs:sequence>

</xs:complexType>

Payment Gateway Account Type.

The Payment Gateway Account Type entity is the data structure definition of the merchant's account in the various Payment Gateways 180. The Payment Gateway Account Type entity includes the attributes employed by the Payment Gateway 180 to uniquely identify the merchant (i.e., the payee) 520, during a payment process. An XML Schema representation of this entity is as shown below:

<xs:complexType name=“PaymentGatewayAccountType”>
<xs:sequence>

<xs:element name=“id” type=“xs:long”/>
<xs:element name=“name” type=“xs:string”/>
<xs:element name=“description” type=“xs:string”/>
<xs:element name=“attributeDefinitions”>
<xs:complexType>

<xs:sequence>
<xs:element name=“attributeDefinition”

maxOccurs=“unbounded”>

<xs:complexType>
<xs:sequence>

<xs:element name=“name” type=“xs:string”/>
<xs:element name=“dataType” type=“xs:string”/>
<xs:element name=“required” type=“xs:boolean”/>
<xs:element name=“secret” type=“xs:boolean”/>

</xs:sequence>
</xs:complexType>

</xs:element>
</xs:sequence>

</xs:complexType>
</xs:element>

</xs:sequence>
</xs:complexType>

Payment Gateway Account.

In order to receive payments through Payment gateway Interface Unit 200, Merchant 520 establishes or registers one or more Payment Gateway Accounts. If Merchant 520 has more than one Payment Gateway Account, then such accounts may be ordered by preference. In one implementation, no two Payment Gateway Accounts of Merchant 520 have the same priority. An XML Schema representation of this entity is as shown below:

<xs:complexType name=“PaymentGatewayAccount”>

<xs:sequence>

<xs:element name=“id” type=“xs:long”/>
<xs:element name=“name” type=“xs:string”/>
<xs:element name=“description” type=“xs:string”/>
<xs:element name=“paymentGatewayAccountTypeId”
type=“xs:long”/>
<xs:element name=“merchantAccountId” type=“xs:long”/>
<xs:element name=“preferenceOrder” type=“xs:int”/>
<xs:element name=“enabled” type=“xs:boolean”/>
<xs:element name=“attributes” type=“pgi:NameValuePairList”/>

</xs:sequence>

</xs:complexType>

Payment Gateway Integration Method.

The Payment Gateway Integration Method entity represents the configuration used to support a specific integration method. This entity includes details such as the name of the integration method, the Payment Gateway the integration method belongs to, the list of Payment Methods the integration method supports (for example, CREDIT_CARD, (INTER)NET_BANKING, DEBIT_CARD etc.), the type of Payment Gateway Account expected for using the integration method, and the order of preference among the list of integration methods for a given Payment Gateway and Payment Gateway Account Type. For a given Payment Gateway and Payment Gateway Account Type, there may be, in one implementation, only one Payment Gateway Adapter 240. An XML Schema representation of this entity is as shown below:

<xs:complexType name=“PaymentGatewayIntegrationMethod”>

<xs:sequence>

<xs:element name=“id” type=“xs:long”/>
<xs:element name=“name” type=“xs:string”/>
<xs:element name=“description” type=“xs:string”/>
<xs:element name=“paymentGatewayId” type=“xs:long”/>
<xs:element name=“paymentGatewayAccountTypeId”
type=“xs:long”/>
<xs:element name=“supportedPaymentMethods”>

<xs:complexType>

<xs:sequence>

<xs:element name=“paymentMethod”

type=“pgi:PaymentMethod”
maxOccurs=“unbounded”/>

</xs:sequence>

</xs:complexType>

</xs:element>
<xs:element name=“paymentGatewayAdapterId”
type=“xs:long”/>
<xs:element name=“preferenceOrder” type=“xs:int”/>
<xs:element name=“enabled” type=“xs:boolean”/>

</xs:sequence>

</xs:complexType>

Payment Gateway Adapter.

The Payment Gateway Adapter entity represents the Payment Gateway Adapters 240 registered in Payment Gateway Interface Unit 200. The attributes of Payment Gateway Adapter 240 can be application specific, if the integration mechanism used is Web Page Redirection. An XML Schema representation of this entity is as shown below:

<xs:complexType name=“PaymentGatewayAdapter”>
<xs:sequence>

<xs:element name=“id” type=“xs:long”/>
<xs:element name=“name” type=“xs:string”/>
<xs:element name=“description” type=“xs:string”/>
<xs:element name=“adapterRoutineId” type=“xs:string”/>
<xs:element name=“enabled” type=“xs:boolean”/>
<xs:element name=“attributes”>
<xs:complexType>

<xs:sequence>
<xs:element name=“attribute” maxOccurs=“unbounded”>

<xs:complexType>
<xs:sequence>

<xs:element name=“applicationKey”
type=“xs:string”/>
<xs:element name=“name” type=“xs:string”/>
<xs:element name=“value” type=“xs:string”/>

</xs:sequence>
</xs:complexType>

</xs:element>
</xs:sequence>

</xs:complexType>
</xs:element>

</xs:sequence>
</xs:complexType>

Payment Interface

The primary functions of Payment Interface 660 are to accept a standard payment request and initiate/complete a payment. In case the payment requires web-page redirection, then Payment Interface 660 is further configured to return a Payment Gateway specific web-request, which can be used for interacting with Payment Gateway 180 as described in connection with web page redirection integration.

Payment interface 660 also processes a Payment Gateway specific web-response and translates the same into a standard payment response, which can be used by client-programs for interpretation. The appropriate Payment Gateway Adapter 240 can be used to assist in connection with the translation function. In addition, payment interface 660 provides a payment request form specific to the configured Payment Gateway, which can be used by the applications to prompt input from the paying user 120.

Other responsibilities of Payment Interface 660 include identifying the appropriate Payment Gateway Adapter 240 based on the given Payment Request and Payment Gateway Integration configurations, publish events once the payment reaches on the three end states of a payment transaction: COMPLETED, FAILED or CANCELLED, Audit various stages of payment transaction, and persist securely all details about the payment transaction.

The various entities related to Payment Interface 660 are shown in FIG. 6C.

Payment Preference.

The Payment Preference entity that is sent by the client-program to the Payment Interface 660 to initiate a payment or to request a Payment Request Form. This entity includes, for example, merchant to which the payment need to be made, Preferred payment method (Credit Card, Debit Card, Net-Banking, online, etc.), and the locale of payer.

An XML Schema representation of this entity is as shown below.

```
<xs:complexType name=“PaymentPreference”>
  <xs:sequence>
    <xs:element name=“merchantId” type=“xs:long”/>
    <xs:element name=“paymentMethod” type=“pgi:PaymentMethod”/>
    <xs:element name=“payerLocale” type=“xs:string”/>
  </xs:sequence>
</xs:complexType>
```

Payment Request.

The Payment Request entity that the client-program employs to send to the Payment interface for initiating the payment. This entity includes Payment Preference details, invoice details (if any), amount being paid along with currency, and/or other details specific to the chosen payment method. For example, if the chosen payment method is Credit Card, the other details include the card number, name of the card owner, expiry date and CVV number. These details are defined as part of the Payment Request Form. Other information comprises the application from which the payment is being made (in one implementation, only the registered apps are allowed to complete payment transactions through the apparatus), and the IP address of the host machine of the payer (for, e.g., security and auditing purposes).

An XML Schema representation of this entity is as shown below

```
<xs:complexType name=“PaymentRequest”>
  <xs:sequence>
    <xs:element name=“merchantId” type=“xs:long”/>
    <xs:element name=“payer” type=“xs:string”/>
    <xs:element name=“paymentMethod” type=“pgi:PaymentMethod”/>
    <xs:element name=“invoiceReferenceId” type=“xs:string”/>
    <xs:element name=“amount”>
      <xs:complexType>
        <xs:sequence>
          <xs:element name=“value” type=“xs:float”/>
          <xs:element name=“currencyCode” type=“xs:string”>
          </xs:element>
        </xs:sequence>
      </xs:complexType>
    </xs:element>
    <xs:element name=“parameters”>
      <xs:complexType>
        <xs:sequence>
          <xs:element name=“parameter” maxOccurs=“unbounded”>
            <xs:complexType>
              <xs:sequence>
                <xs:element name=“name” type=“xs:string”/>
                <xs:element name=“value” type=“xs:string”/>
              </xs:sequence>
            </xs:complexType>
          </xs:element>
        </xs:sequence>
      </xs:complexType>
    </xs:element>
    <xs:element name=“payerLocale” type=“xs:string”/>
    <xs:element name=“hostAddress” type=“xs:string”/>
  </xs:sequence>
</xs:complexType>
```

Payment Response.

The Payment Response entity is the entity that the Payment Interface 660 returns to the client-program once the given Payment Request is processed. This entity includes at payment status code (COMPLETED, FAILED, CANCELLED or REDIRECT), and if the status code is COMPLETED then the payment details may further include invoice reference details, amount paid along with currency, transaction reference id, and time of payment. If the status code is REDIRECT, then the Payment Gateway Web Request is employed.

An XML Schema representation of this entity is as shown below.

```
<xs:complexType name=“PaymentResponse”>
  <xs:sequence>
    <xs:element name=“transactionReferenceId” type=“xs:string”/>
    <xs:element name=“statusCode”>
      <xs:simpleType>
          <xs:restriction base=“xs:string”>
            <xs:enumeration value=“COMPLETED”/>
            <xs:enumeration value=“REDIRECT”/>
            <xs:enumeration value=“CANCELLED”/>
            <xs:enumeration value=“FAILED”/>
            <xs:enumeration value=“value”/>
          </xs:restriction>
      </xs:simpleType>
    </xs:element>
    <xs:element name=“paymentDetails”
type=“pgi:PaymentDetails”/>
    <xs:element name=“paymentGatewayWebRequest”
                type=“pgi:PaymentGatewayWebRequest”/>
  </xs:sequence>
</xs:complexType>
```

An schema of type pgi:PaymentDetails is as shown below.

<xs:complexType name=“PaymentDetails”>
<xs:sequence>

<xs:element name=“transactionReferenceId” type=“xs:string”/>
<xs:element name=“submittedOn” type=“xs:dateTime”/>
<xs:element name=“paidOn” type=“xs:dateTime”/>
<xs:element name=“payer” type=“xs:string”/>
<xs:element name=“applicationKey” type=“xs:string”/>
<xs:element name=“invoiceReferenceId” type=“xs:string”/>
<xs:element name=“amount” type=“pgi:Money”/>
<xs:element name=“paymentGatewayUsed” type=“xs:long”/>
<xs:element name=“paymentGatewayAccountUsed”

type=“xs:long”/>
</xs:sequence>
</xs:complexType>

Payment Request Form.

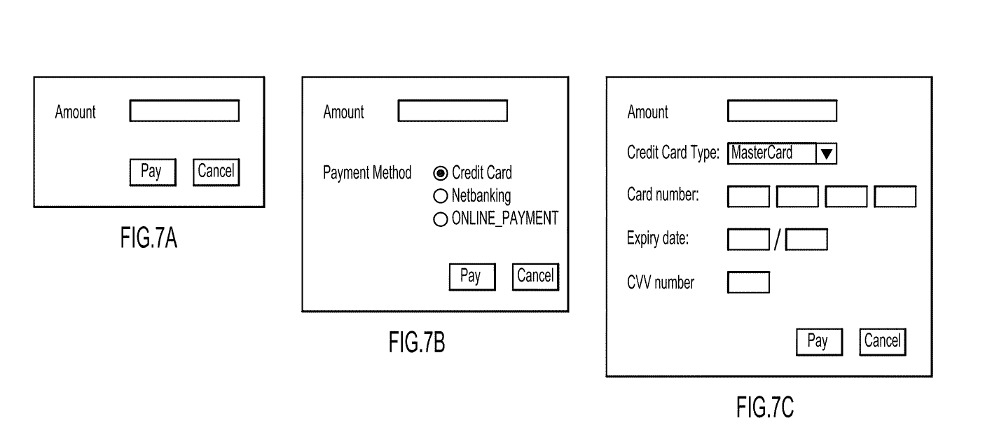

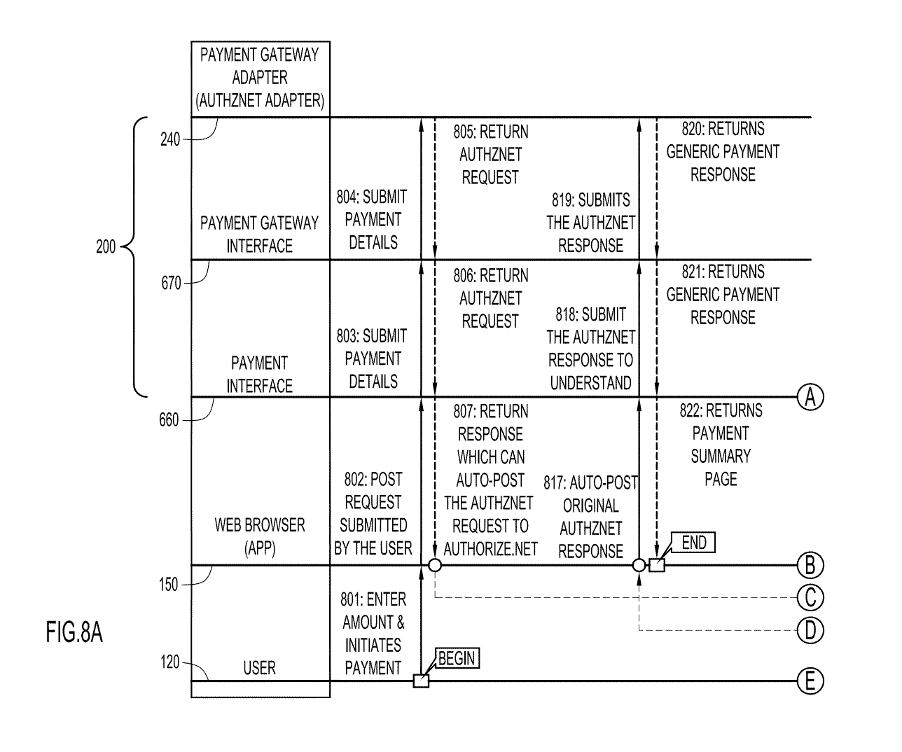

This entity is the entity that Payment Interface 660 returns when the client-program requests for a list of inputs required in addition to the attributes defined in Payment Request. FIGS. 7A-7C show sample payment request forms that may be supplied to Web Application 150 for User 120 to complete.

This entity includes form name and description (if any), form label based on the preferred locale, a flag indicating whether the input parameters defined in the form are mandatory or not. The entity may further include a list of form-fields where each form-field includes the name of the form-field, the label based on the locale of the context-user, a flag stating whether the field is required, hidden and secret, options (with value and label) which can be prompted to the user, and the data-type of the value expected, where data-type should include (STRING, NUMBER, BOOLEAN, DATE, CURRENCY, ENUM, LIST).

An XML Schema representation of this entity is as shown below.

```
<xs:complexType name=“PaymentRequestForm”>
  <xs:sequence>
    <xs:element name=“name” type=“xs:string”/>
    <xs:element name=“description” type=“xs:string”/>
    <xs:element name=“required” type=“xs:boolean”/>
    <xs:element name=“forms”>
      <xs:complexType>
        <xs:sequence>
          <xs:element name=“form” maxOccurs=“unbounded”
                      type=“pgi:PaymentRequestForm”/>
        </xs:sequence>
      </xs:complexType>
    </xs:element>
    <xs:element name=“fields”>
      <xs:complexType>
        <xs:sequence>
          <xs:element name=“field” maxOccurs=“unbounded”>
            <xs:complexType>
              <xs:sequence>
                <xs:element name=“dataType” type=“xs:string”/>
                <xs:element name=“name” type=“xs:string”/>
                <xs:element name=“description” type=“xs:string”/>
                <xs:element name=“required” type=“xs:boolean”/>
                <xs:element name=“secret” type=“xs:boolean”/>
                <xs:element name=“options”>
                  <xs:complexType>
                    <xs:sequence>
                      <xs:element name=“option”
                      maxOccurs=“unbounded”>
                        <xs:complexType>
                          <xs:sequence>
                            <xs:element name=“label”
                            type=“xs:string”/>
                            <xs:element name=“value”
                            type=“xs:string”/>
                          </xs:sequence>
                        </xs:complexType>
                      </xs:element>
                    </xs:sequence>
                  </xs:complexType>
                </xs:element>
              </xs:sequence>
            </xs:complexType>
          </xs:element>
        </xs:sequence>
      </xs:complexType>
    </xs:element>
  </xs:sequence>
</xs:complexType>
```

Payment Gateway Web Request.

The Payment Gateway Web Request is the entity that is created by the Payment Gateway Adapter 240 and given to Payment Interface 660, when the payment operation requires the client-programs assistance in redirecting the web request to a website of Payment Gateway 180. This entity includes the HTTP method to be used (GET, POST or PUT), the URL to which the HTTP request is to be sent, the list of query parameters and form parameters to be sent as part of the HTTP request and the list of HTTP headers to be used while constructing the HTTP request.

An XML Schema representation of this entity is as shown below.

```
<xs:complexType name=“PaymentGatewayWebRequest”>
  <xs:sequence>
    <xs:element name=“uri” type=“xs:string”/>
    <xs:element name=“httpRequestMethod”>
      <xs:simpleType>
        <xs:restriction base=“xs:string”>
          <xs:enumeration value=“GET”/>
          <xs:enumeration value=“POST”/>
        </xs:restriction>
      </xs:simpleType>
    </xs:element>
    <xs:element name=“headers” type=“pgi:NameValuePairList”/>
    <xs:element name=“parameters” type=“pgi:NameValuePairList”/>
  </xs:sequence>
</xs:complexType>
```

Payment Gateway Web Response.

The Payment Gateway Web Response entity is created by the Payment Gateway 180 and sent to the client-program through a HTTP-POST or HTTP-GET request. As the client-program does not know how to interpret the data, the client-program copies the request parameters, query string, headers and body into this entity and submits the completed entity to the Payment interface 660 for converting it into a standard Payment Response. The list of attributes of this entity includes, the Payment Gateway host IP address and locale, the body of the HTTP request, the list of query parameters and form parameters sent as part of the HTTP request and the list of HTTP headers sent as part of the HTTP request.

An XML Schema representation of this entity is as shown below.

```
<xs:complexType name=“PaymentGatewayWebResponse”>
  <xs:sequence>
    <xs:element name=“body” type=“xs:string”/>
    <xs:element name=“headers” type=“pgi:NameValuePairList”/>
    <xs:element name=“parameters” type=“pgi:NameValuePairList”/>
  </xs:sequence>
</xs:complexType>
```

Payment Transaction.

The Payment Transaction entity is created by Payment Interface 660 once a payment is initiated. The list of attributes of this includes the start time and end time of the payment transaction, the status of the transaction (COMPLETED, FAILED, CANCELLED or INPROGRESS), the Payment Request details, the Payment Gateway Integration settings used to identify the Payment Gateway Adapter 240 and the payee and payer details.

An XML Schema of this entity is as shown below.

```
<xs:complexType name=“PaymentTransaction”>
  <xs:sequence>
    <xs:element name=“transactionReferenceId” type=“xs:string”/>
    <xs:element name=“startedOn” type=“xs:dateTime”/>
    <xs:element name=“endedOn” type=“xs:dateTime”/>
    <xs:element name=“payer” type=“xs:string”/>
    <xs:element name=“merchantId” type=“xs:long”/>
    <xs:element name=“merchantName” type=“xs:string”/>
    <xs:element name=“amount” type=“pgi:Money”/>
    <xs:element name=“paymentGatewayAdapterId” type=“xs:long”/>
    <xs:element name=“paymentGatewayAdapterName”
type=“xs:string”/>
    <xs:element name=“paymentGatewayAccountId” type=“xs:long”/>
    <xs:element name=“paymentGatewayAccountName”
type=“xs:string”/>
    <xs:element name=“status”>
      <xs:simpleType>
        <xs:restriction base=“xs:string”>
          <xs:enumeration value=“INPROGRESS” />
          <xs:enumeration value=“COMPLETED” />
          <xs:enumeration value=“CANCELLED” />
          <xs:enumeration value=“FAILED” />
        </xs:restriction>
      </xs:simpleType>
    </xs:element>
  </xs:sequence>
</xs:complexType>
```

Payment Transaction Management Interface

The primary functions of Payment Transaction Management Interface 665 are to fetch the list of Payment Transactions performed by a given user or performed towards a given use, to identify all in-progress and hung Payment Transactions, to manually cancel the hung Payment Transactions, and to fetch all details about a given Payment Transaction to help investigate reported problems.

In order to assist investigation, this interface supports one other flavor of Payment Transaction with all relevant details. An XML Schema of this entity is as shown below.

```
<xs:complexType name=“PaymentTransactionDetails”>
  <xs:sequence>
    <xs:element name=“transactionReferenceId” type=“xs:string”/>
    <xs:element name=“startedOn” type=“xs:dateTime”/>
    <xs:element name=“endedOn” type=“xs:dateTime”/>
    <xs:element name=“merchant” type=“pgi:Merchant”/>
    <xs:element name=“paymentRequest” type=“pgi:PaymentRequest”/>
    <xs:element name=“paymentGatewayAdapter”
                type=“pgi:PaymentGatewayAdapter”/>
    <xs:element name=“paymentGatewayAccount”
                type=“pgi:PaymentGatewayAccount”/>
    <xs:element name=“paymentGatewayIntegrationMethod”
                type=“pgi:PaymentGatewayIntegrationMethod”/>
    <xs:element name=“status”>
      <xs:simpleType>
            <xs:restriction base=“xs:string”>
          <xs:enumeration value=“INPROGRESS”/>
          <xs:enumeration value=“COMPLETED”/>
              <xs:enumeration value=“CANCELLED”/>
              <xs:enumeration value=“FAILED”/>
            </xs:restriction>
      </xs:simpleType>
    </xs:element>
    <xs:element name=“transactionRecords”>
      <xs:complexType>
        <xs:sequence>
          <xs:element name=“transactionRecord”
          maxOccurs=“unbounded”>
            <xs:complexType>
              <xs:sequence>
                <xs:element name=“code” type=“xs:string”/>
                <xs:element name=“message” type=“xs:string”/>
                <xs:element name=“attributes”
                type=“pgi:NameValuePairList”/>
                <xs:element name=“createdOn” type=“xs:dateTime”/>
              </xs:sequence>
            </xs:complexType>
          </xs:element>
        </xs:sequence>
      </xs:complexType>
    </xs:element>
  </xs:sequence>
</xs:complexType>
```

Payment Gateway Adapter Interface

The functions of Payment Gateway Adapter interfaces 670 are to fetch the Payment Request Form for the given Payment Preference, perform payment for the given Payment Request, process the Payment Gateway Response and perform the payment (in case of Web Page Redirection).

Referring again to FIG. 6A, the interaction among the several interfaces discussed above can be seen. At 601, Payment Interface 660 receives a payment request. Using Payment Gateway Integration Configuration Interface 655, at 602, a Payment Gateway Integration Method suitable to process the given payment request is selected. At 603, the selected suitable Payment Gateway Integration Method is returned to Payment Interface 660. At 604, a Payment Transaction is created. At 605, the status, Payment Request and Payment Gateway Integration Method details are “persisted” in Payment Transaction 272. At 606, the Payment Request along with the Payment Gateway Adapter properties are submitted to Payment Gateway Adapter 240 via Payment Adapter Interface 670. At 607 a standard Payment Gateway response is returned to Payment Interface 660, and at 608, the standard Payment Response is returned to Web Application 150.

To facilitate and standardize the exchange of information between interfaces, the following data types may be employed.

### PaymentMethod

```
<xs:simpleType name=“PaymentMethod”>
  <xs:restriction base=“xs:string”>
    <xs:enumeration value=“CREDIT_CARD”/>
    <xs:enumeration value=“NET_BANKING”/>
    <xs:enumeration value=“DEBIT_CARD”/>
    <xs:enumeration value=“CASH_CARD”/>
    <xs:enumeration value=“ONLINE”/>
  </xs:restriction>
</xs:simpleType>
```

### Money

```
<xs:complexType name=“Money”>
  <xs:sequence>
    <xs:element name=“value” type=“xs:float”/>
    <xs:element name=“currencyCode” type=“xs:string”/>
  </xs:sequence>
</xs:complexType>
```

### NameValuePair

```
<xs:complexType name=“NameValuePair”>
  <xs:sequence>
    <xs:element name=“name” type=“xs:string”/>
    <xs:element name=“value” type=“xs:string”/>
  </xs:sequence>
</xs:complexType>
```

### NameValuePairList

```
<xs:complexType name=“NameValuePairList”>
  <xs:sequence>
    <xs:element name=“item” type=“pgi:NameValuePair”
maxOccurs=“unbounded”/>
  </xs:sequence>
</xs:complexType>
```

### Message

```
<xs:complexType name=“Message”>
  <xs:sequence>
    <xs:element name=“summary” type=“xs:string”/>
    <xs:element name=“details” type=“xs:string”/>
    <xs:element name=“code” type=“xs:string”/>
    <xs:element name=“type”>
      <xs:simpleType>
        <xs:restriction base=“xs:string”>
          <xs:enumeration value=“INFO”/>
          <xs:enumeration value=“WARNING”/>
          <xs:enumeration value=“ERROR”/>
        </xs:restriction>
      </xs:simpleType>
    </xs:element>
  </xs:sequence>
</xs:complexType>
```

### MessageList

```
<xs:complexType name=“MessageList”>
  <xs:sequence>
    <xs:element name=“item” type=“pgi:Message”
    maxOccurs=“unbounded”/>
  </xs:sequence>
</xs:complexType>
```

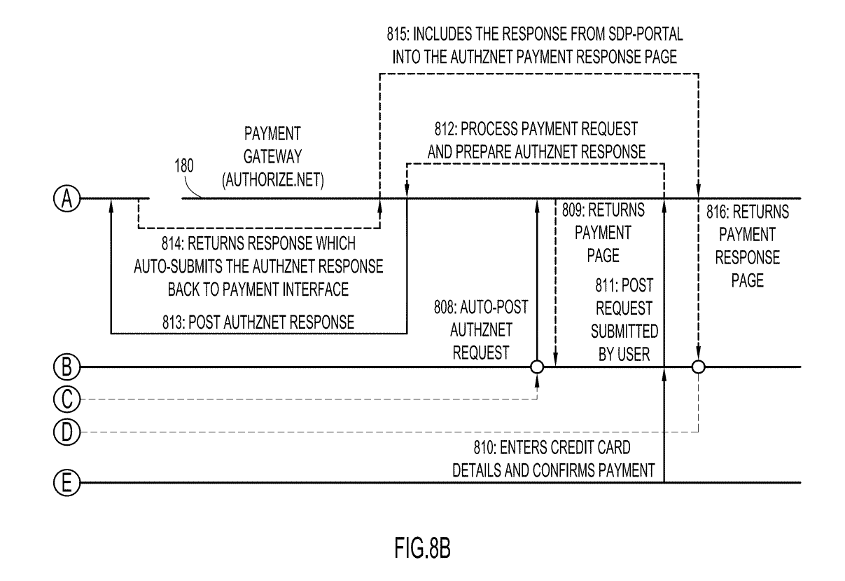

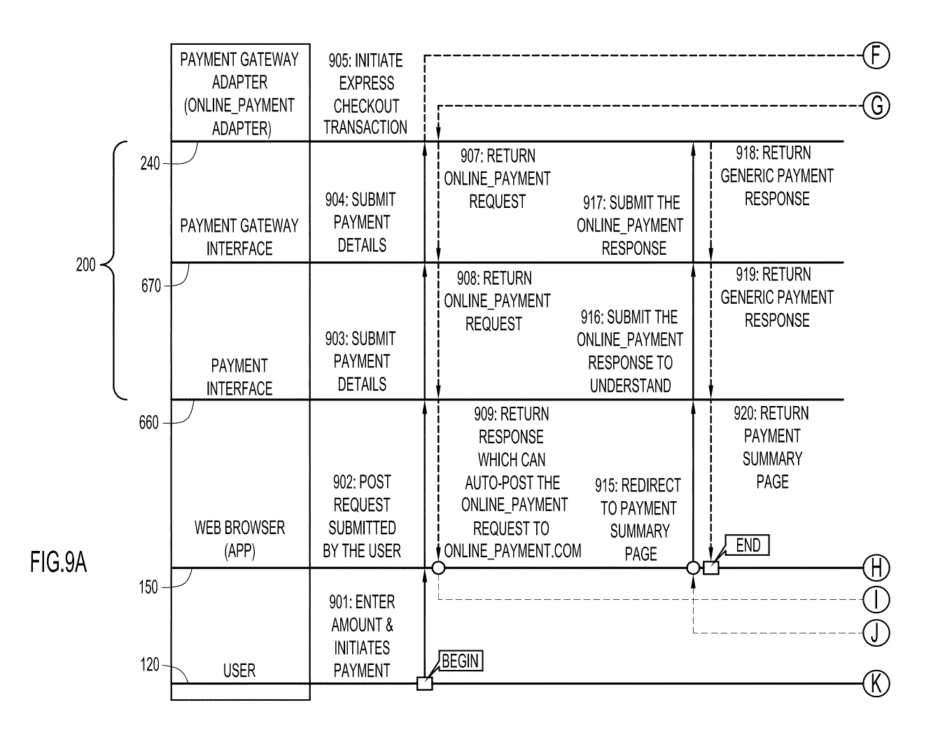

FIGS. 8A and 8B are flowcharts showing one example of operations performed to conduct a financial transaction using a credit card and Payment Gateway Interface Unit 200 according to an embodiment. As shown, at 801, user 120 enters an amount and initiates payment while using Web Application 150. At 802, Web Application 150 POSTs the request submitted by user 120 to Payment Interface 660, which in turn, at 803, submits payment details to Payment Gateway Interface 670. The payment details, at 804, are then submitted to Payment Gateway Adapter 240 that generates an appropriate credit card (AuthzNet) Request that is passed back to Web Application 150 via Payment Gateway Interface 670, and Payment Interface 660 as indicated by 805, 806 and 807.

At 808, Web Application 150 is configured to Auto-POST the AuthzNet Request to Payment Gateway 180 (in this case Authorize.net). This triggers Payment gateway 180, at 809, to return a payment page to Web Application 150, whereupon user 120, at 810, enters credit card details and confirms payment. At 811, the request submitted by user 120 is POSTed to Payment Gateway 180. At 812, Payment gateway 180 processes the Payment Request and prepares an AuthZnet response, which is transmitted at 813 to Payment Interface 660. At 814, Payment Interface 660 returns a response which is configured to be auto-submitted back to Payment Interface 660. At 815, Payment Gateway 180 incorporates the response from Payment Interface 660 in the AuthZnet payment response page and, at 816, returns the payment response page to Web Application 150.

At 817, Web Application 150 auto-POSTs the AuthZnet response and passes the same to Payment Interface 660, which, at 818, submits the AuthZnet response to Payment gateway Interface 670, which, in turn, at 819, submits the AuthZnet response to Payment Gateway Adapter 240. Payment Gateway Adapter 240 (which is configured to understand the AuthZnet-specific response) generates and, at 820 passes a generic payment response to Web Application 150 via Payment Gateway Interface 670 and Payment Interface 660 as indicated by 821 and 822.

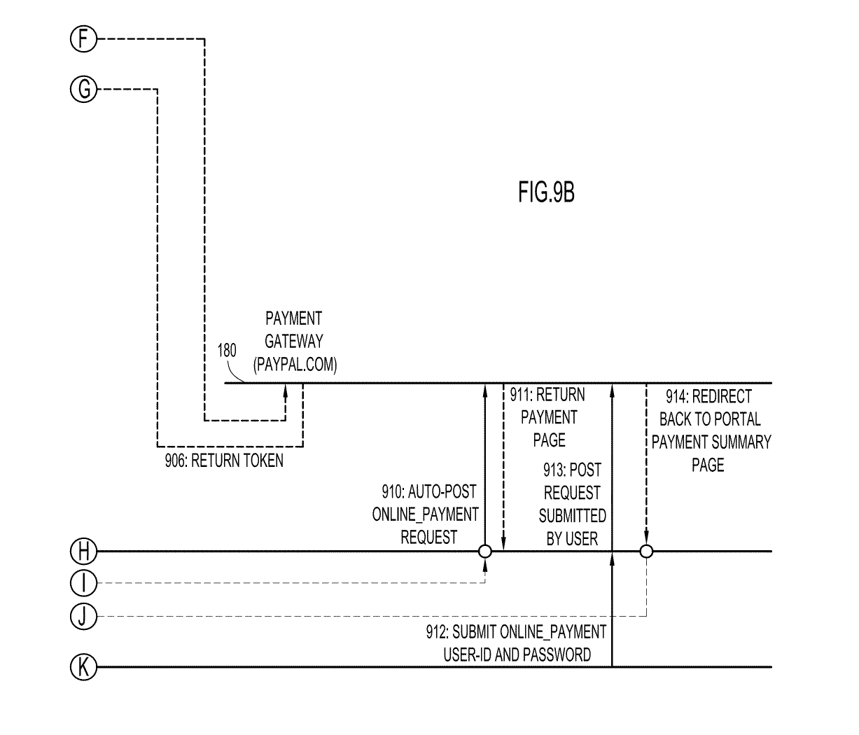

FIGS. 9A and 9B are flowcharts showing one example of operations performed to conduct a financial transaction using an online payment via Payment Gateway Interface Unit 200 according to an embodiment.

As shown, at 901, user 120 enters an amount and initiates payment while using Web Application 150. At 902, Web Application 150 POSTs the request submitted by user 120 to Payment Interface 660, which in turn, at 903, submits payment details to Payment Gateway Interface 670. The payment details, at 904, are then submitted to Payment Gateway Adapter 240 that initiates an Express Checkout Transaction directed to OnLine_Payment.com (e.g., PayPal.com). At 906, OnLine_Payment.com returns a token to Payment Gateway Adapter 240. That token (in the form of a Return OnLine_Payment Request) is passed to Web Application 150 via Payment Gateway Interface 670 and Payment Interface 660 as indicated by 907, 908 and 909. Note that Payment Interface 660 provides a Return response which can auto-POST the OnLine_Payment Request to OnLine_Payment.com.

At 910, Web Application 150 is configured to Auto-POST the OnLine_Payment Request to Payment Gateway 180 (in this case OnLine_Payment.com). This triggers Payment gateway 180, at 911, to return a payment page to Web Application 150, whereupon user 120, at 912, enters his OnLine_Payment user identification and password. At 913, the request submitted by user 120 is POSTed to Payment Gateway 180. At 914, Payment gateway 180 redirects to Web Application 150.

At 915, Web Application 150 is redirected to a payment summary page via Payment Interface 660. At 916, Payment Interface 660 submits the payment to understand (e.g., the OnLine_Payment response) to Payment Gateway Adapter 670, which, at 917, submits the OnLine_Payment response to Payment Gateway Adapter 240, which, at 918, returns a generic payment response to Web Application 150 via Payment Gateway Interface 670 and Payment Interface 660 as indicated by 919 and 920, where at 920 a payment summary page is returned.

Those skilled in the art will appreciate that the foregoing methodologies provide several benefits. For example, the described Payment Gateway Interface Unit 200 helps Web Applications 150 to use generic code to perform payments through any Payment Gateway 180 and track the payment transactions. A standard interface is provided for developers to develop Adapters for various Payment Gateways. The methodologies further provide a standard interface for system integrators to subscribe to and listen to payment related events, enable Web Applications to register and manage one or more merchants and their Payment Gateway accounts at runtime, and enable seamless switching between payment gateways at runtime through configuration changes. The several disclosed can be made available in a cloud computing environment as RESTful Web Services for cloud-based applications. Finally, the methodologies described herein may be effective in reducing cost of development and testing Payment Gateway integration in Web Applications.

The above description is intended by way of example only. Various modifications and structural changes may be made therein without departing from the scope of the concepts described herein and within the scope and range of equivalents of the claims.

What is claimed is:

1. A computer-implemented method comprising:
receiving a generic payment request from an electronic commerce web application, the generic payment request including at least an indication of a type of payment to be completed;
preparing a payment gateway-specific web request that is supportive of the type of payment to be completed;
passing the payment gateway-specific web request to the electronic commerce web application for delivery to a payment gateway for which the payment gateway-specific web request was prepared;
receiving a payment gateway-specific web response from the payment gateway via the electronic commerce web application;
processing the payment gateway-specific web response; and
returning, to the electronic web application, a generic payment response including, at least, an Internet Protocol (IP) address of the payment gateway.

2. The computer-implemented method of claim 1, wherein preparing the payment gateway-specific web request comprises preparing the payment gateway-specific web request with a payment gateway adapter.

3. The computer-implemented method of claim 2, further comprising passing the payment gateway-specific web request to the electronic commerce web application for delivery to the payment gateway by passing an XML file from the payment gateway adapter to the electronic web application.

4. The computer-implemented method of claim 1, wherein processing the payment gateway-specific web response comprises processing the payment gateway-specific web response with a payment gateway adapter.

5. The computer-implemented method of claim 4, wherein processing the payment gateway-specific web response comprises generating an XML file including, at least, the IP address of the payment gateway.

6. The computer-implemented method of claim 1, wherein the type of payment is one of a credit card payment, a debit card payment, an Internet banking payment, a cash card payment, or a web-based payment application.

7. A computer-implemented method, comprising:
receiving a generic payment request for a payment transaction from an electronic commerce web application, the generic payment request including at least an indication of a type of payment to be completed;
preparing a payment gateway-specific request that is supportive of the type of payment to be completed;
sending the payment gateway-specific request to a payment gateway for which the payment gateway-specific request was prepared;
receiving a payment gateway-specific response from the payment gateway;
processing the payment gateway-specific response; and
returning, to the electronic commerce web application, a generic payment response including, at least, an indication that the payment transaction has completed.

8. The computer-implemented method of claim 7, wherein preparing the payment gateway-specific request comprises preparing the payment gateway-specific request with a payment gateway adapter.

9. The computer-implemented method of claim 8, further comprising passing the payment gateway-specific request to the payment gateway without passing through the electronic commerce web application.

10. The computer-implemented method of claim 7, wherein processing the payment gateway-specific response comprises processing the payment gateway-specific response with a payment gateway adapter.

11. An apparatus, comprising:
a network interface unit configured to enable network communications with at least one payment gateway and an electronic commerce web application;
a memory configured to store logic instructions; and
a processor, when executing the logic instructions, configured to:
receive, via the network interface unit, a generic payment request from an electronic commerce web application, the generic payment request including at least an indication of a type of payment to be completed;
prepare a payment gateway-specific web request that is supportive of the type of payment to be completed;
pass the payment gateway-specific web request to the electronic commerce web application for delivery to a payment gateway for which the payment gateway-specific web request was prepared;
receive a payment gateway-specific web response from the payment gateway via the electronic commerce web application;
process the payment gateway-specific web response; and
return, to the electronic web application, a generic payment response including, at least, an Internet Protocol (IP) address of the payment gateway

12. The apparatus of claim 11, wherein the processor, when executing the logic instructions, is further configured to:
prepare the payment gateway-specific web request by preparing the payment gateway-specific web request with a payment gateway adapter.

13. The apparatus of claim 11, wherein the processor, when executing the logic instructions, is further configured to:
pass the payment gateway-specific web request to the electronic commerce web application for delivery to the payment gateway by passing an XML file from the payment gateway adapter to the electronic web application.

14. The apparatus of claim 11, wherein the processor, when executing the logic instructions, is further configured to:
process the payment gateway-specific web response by processing the payment gateway-specific web response with a payment gateway adapter.

15. The apparatus of claim 11, wherein the processor, when executing the logic instructions, is further configured to:
process the payment gateway-specific web response by generating an XML file including, at least, the IP address of the payment gateway.

16. The apparatus of claim 11, wherein the type of payment is one of a credit card payment, a debit card payment, or a web-based payment application.

17. An apparatus comprising:
a network interface unit configured to enable network communications with at least one payment gateway and an electronic commerce web application;
a memory configured to store logic instructions; and
a processor, when executing the logic instructions, configured to:
receive a generic payment request for a payment transaction from an electronic commerce web application, the generic payment request including at least an indication of a type of payment to be completed;
prepare a payment gateway-specific request that is supportive of the type of payment to be completed;
send the payment gateway-specific request to a payment gateway for which the payment gateway-specific request was prepared;
receive a payment gateway-specific response from the payment gateway;
process the payment gateway-specific response; and
return, to the electronic commerce web application, a generic payment response including, at least, an indication that the payment transaction has completed.

18. The apparatus of claim 17, wherein the processor, when executing the logic instructions, is further configured to:
prepare the payment gateway-specific request by preparing the payment gateway-specific request with a payment gateway adapter.

19. The apparatus of claim 17, wherein the processor, when executing the logic instructions, is further configured to:
pass the payment gateway-specific request to the payment gateway without passing through the electronic commerce web application.

20. The apparatus of claim 17, wherein the processor, when executing the logic instructions, is further configured to:
process the payment gateway-specific response by processing the payment gateway-specific response with a payment gateway adapter.
